(19) United States
(12) Patent Application Publication
(10) Pub. No.: US 2019/0197102 A1
(43) Pub. Date: Jun. 27, 2019

(54) Predictive Contextual Messages

(71) Applicant: PayPal, Inc., San Jose, CA (US)

(72) Inventors: Brandon Lerner, San Jose, CA (US); Ryan Sullivan, San Jose, CA (US)

(21) Appl. No.: 15/855,371

(22) Filed: Dec. 27, 2017

(51) Int. Cl. G06F 17/27; G06F 3/023; G06Q 20/32; H04L 12/58; G06F 3/0481

(52) U.S. Cl. CPC G06F 17/276; G06F 3/0237; G06F 3/04817; H04L 51/046; G06Q 20/3221

(57) ABSTRACT

Systems and methods for predictive contextual messages are provided. Such predictive contextual messages may utilize emojis and/or emoticons for predicting context of messages and allow for auto-fill of details. Accordingly, a user may input a message, that may contain one or more emojis and/or emoticons, and transaction details may be determined through contexts of the message and may be provided as an auto-fill suggestion. The user may then accept or reject the auto-fill suggestion.

### BACKGROUND

### Field of the Invention

The present invention generally relates to predictive algorithms, and more specifically to predictive algorithms that utilize emojis, emoticons, and other electronic messaging images.

### Related Art

As users engage in greater numbers of transactions, providing details for each of the transactions is consuming a greater amount of a user's time. For example, within a typical transaction, the user may be required to enter details about a recipient, an amount of the transaction, a purpose of the transaction, as well as other details. Individually inputting the recipient, amount of the transaction, purpose of the transaction, and other information for each transaction conducted by the user may require large amounts of time that a user may not have.

Additionally, users are increasingly using emojis and emoticons within their messages. Emojis and emoticons can be used to provide and express information in a much more efficient manner than textual language.

### BRIEF DESCRIPTION OF THE FIGURES

FIG. 1 is a block diagram showing a system according to an embodiment of the disclosure.

FIG. 2 is a block diagram showing an electronic device according to an embodiment of the disclosure.

FIGS. 3A-C are views of an example graphical user interface (GUI) showing a transaction using predictive contextual messages according to an embodiment of the disclosure.

FIG. 4 is a flowchart showing an example of a transaction utilizing predictive contextual messages according to an embodiment of the disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure describes systems and methods utilizing predictive contextual messages. Such predictive contextual messages may predict the context of a transaction even when incomplete information is provided. The predictive context messages described herein may utilize emojis and/or emoticons for predictions. Accordingly, a user may input one or more emojis and/or emoticons, and a prediction of the message and/or details of a transaction associated with the emojis and/or emoticons may be automatically provided.

In certain embodiments, user information used for predictive contextual messages may be stored within a transaction database. Such user information may include historical transactions of the users. User information, such as one or more historical transactions, may be associated with the one or more emojis, emoticons, user location, time period (e.g., time of the month), relationship to the recipient, or other aspect of a user message. Such data may be associated with each instance of the user information, such as each historical transaction, through a match score. The match score may quantify how likely data corresponding to the user message is associated with the user information in each instance that the data is provided or obtained. Recurring user transactions that are consistently associated with an emoji, emoticon, user location, time period, user contact, or other aspect may be assigned a higher match score to signify a tighter or closer relationship. Thus, when a user is conducting a transaction, details of the transaction may be automatically filled based on user input of emojis or emoticons, user location, time period (e.g., time of the month), relationship to the recipient, or other message data.

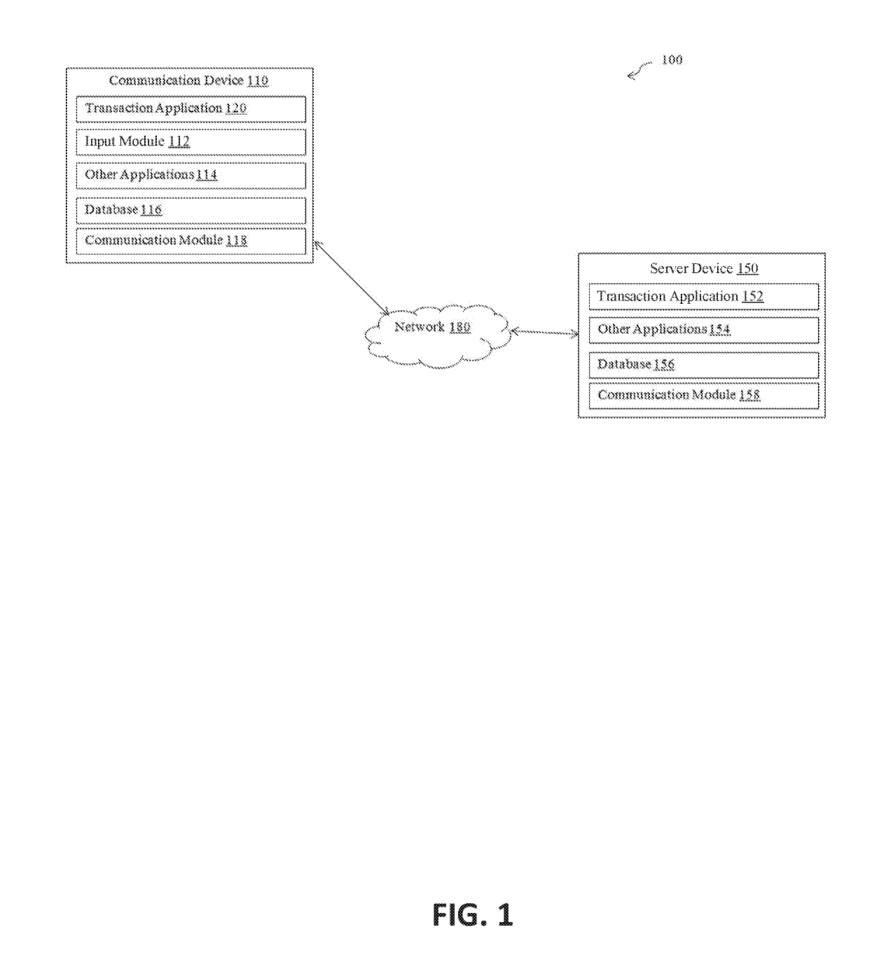

FIG. 1 is a block diagram showing a system according to an embodiment of the disclosure. As shown, system 100 may include or implement a plurality of devices, platforms, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, iOS®, Android®, or other suitable device and/or server or mobile based OS. It can be appreciated that the device and/or server illustrated in FIG. 1 may be deployed in other ways and that the operations performed and/or the services provided by such a device and/or server may be combined or separated for a given embodiment and may be performed by a greater number or fewer number of devices and/or servers. One or more such devices and/or servers may be operated and/or maintained by the same or different entities.

System 100 includes a communication device 110 and a server device 150 in communication over a network 180. A user may utilize communication device 110 to, for example, conduct one or more transactions and/or communicate with one or more contacts. Communication device 110 and server device 150 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 180.

Communication device 110 may be implemented as an electronic device that may utilize appropriate hardware and software configured for wired and/or wireless communication with server device 150. In one embodiment, communication device 110 may be implemented as a personal computer (PC), telephonic device, a smart phone, laptop/tablet computer, wristwatch with appropriate computer hardware resources, eyeglasses with appropriate computer hardware (e.g. GOOGLE GLASS®), other type of wearable computing device, implantable electronic devices, and/or other types of computing devices capable of communicating over network 180, such as an IPAD® from APPLE®. Communication device 110 may be managed or controlled by any suitable processing device internal or external to the electronic device.

Communication device 110 of FIG. 1 may include a transaction application 120, an input module 112, other applications 114, a database 116, and a communication module 118. Transaction application 120, input module 112, and other applications 114 may correspond to executable processes, procedures, and/or applications with associated hardware. In other embodiments, communication device 110 may include additional or different modules having specialized hardware and/or software as required, such as sensors and output devices.

Transaction application 120 may correspond to one or more processes to execute software modules and associated devices of communication device 110 to conduct one or more transactions or communications associated with the user. In certain embodiments, transaction application 120 may allow for a user to conduct one or more transactions using the application and the electronic device. Such an application may be, for example, a dedicated purchasing application linked with a transaction service (e.g., eBay®), a merchant (e.g., Nordstrom®), and/or a payment service (e.g., PayPal® or Venmo®). The transaction application 120 may be a single application or a plurality of separate applications linked together. Thus, for example, the transaction application 120 may be a combination of a purchasing application, a payment application, and a communication application. In various embodiments, transaction application 120 may also include financial applications, such as banking, online payments, money transfer, or other applications.

Input module 112 may be hardware or software configured to receive a user input. For example, input module 112 may be a physical keyboard, a virtual keyboard (e.g., a keyboard on a touchscreen of communication device 110), a mouse, a tracking device, a gesture detection module, and/or other such component for receiving input from a user of communication device 110. Input module 112 may communicate with transaction application 120 to allow a user to provide inputs to transaction application 120.

In certain embodiments, transaction application 120 may receive user inputs from input module 112. Such inputs may not fully detail the transaction and/or message (e.g., one or more of a recipient, a transaction amount, a purpose for the transaction, a timeframe for the transaction, and/or another such detail may be not be inputted by the user). Instead, transaction application 120 may predict such details by analyzing the inputs and other data associated with the message using historical data (e.g., historical transaction data) stored on communication device 110 and/or may communicate such inputs to server device 150 and receive data (e.g., a prediction of the details) in response to the communications from server device 150. If the inputs are communicated to or obtained by server device 150, transaction application 152 may predict and/or aid in predicting such details. The details may then be provided to transaction application and shown as a possible auto-fill to the user. The user may then accept, revise, or reject the auto-fill data.

In certain such embodiments, such inputs may include one or more emojis or emoticons. Certain embodiments may convert (e.g., by transaction application 120 and/or 152) such emojis or emoticons to corresponding words or phrases and/or may utilize the emojis or emoticons in its native form to determine matches for the inputs from stored historical transaction data.

Inputs, including any emojis and/or emoticons, may match one or more historical transactions and/or messages of the user. Such matches may be stored as a percentage match between the inputs and the historical transactions and/or messages. Thus, the emoji “h” may symbolize a house and such an emoji may match “mortgage payment,” “rent payment,” “utilities,” “furniture purchase,” and/or other such transactions to varying degrees for the particular user. Such matches may be improved through use of additional emojis. Accordingly, the emoji combination “ [symbol] ” may symbolize a house related payment on the first of the month and so may more closely match “rent payment” than “mortgage payment,” “utilities,” “furniture purchase,” and/or other transactions. Thus, transaction application 120 and/or 152, when provided with the input “ [symbol] ” may provide rent payment details (e.g., may auto-fill in the landlord as the recipient, the rental amount, and schedule the payment to be conducted on the first of the month) as the first suggested auto-fill. The user may then accept, revise, or reject any or all of the auto-filled data.

Acceptance, revision, or rejection of provided auto-fills may be noted by transaction application 120 and/or 152, and transaction application 120 and/or 152 may then update match scores of the inputs in relation to the historical transactions and/or messages. Accordingly, if the user accepts the auto-fill, the match score between the input and the historical transaction and/or message may be increased (e.g., the percentage match may be increased) while if the user rejects the auto-fill, the match between the input and the historical transaction and/or message may be decreased. How much or how little the user revises the auto-filled data may also be used to update a match score. Such matches may be matches between historical transactions and the entirety of the input, a portion of the input (e.g., matches to only the emojis contained with an input), and/or one character of the input (e.g., matches to one emoji of the input). Such historical transactions and/or matches may be stored as data within, for example, database 116 and/or 156, as further described herein.

Referring back to communication device 110, in various embodiments, communication device 110 includes other applications 114 as may be desired in particular embodiments to provide features to communication device 110. For example, other applications 114 may include security applications for implementing client-side security features, programmatic client applications for interfacing with appropriate application programming interfaces (APIs) over network 180, or other types of applications. Other applications 114 may also include email, texting, voice and IM applications that allow a user to send and receive emails, calls, texts, and other notifications through network 180. Other applications 114 may also include other location detection applications, which may be used to determine a location for the user, such as a mapping, compass, and/or GPS application, which can include a specialized GPS receiver that obtains location information for communication device 110 and processes the location information to determine a location of communication device 110 and the user. Other applications may include social networking applications, media viewing, and/or merchant applications.

Other applications 114 may also be associated with other electronic devices, such as biometric tracking devices and other types of accessible or connected devices (e.g., connected to communication devices 110 through a Bluetooth® connection). Thus, in certain embodiments, other applications 114 may be located or operated on such other electronic devices that are connected to communication devices 110 and the output of operating such other applications 114 may then be provided to communication devices 110. Other applications 114 may be utilized to determine user data or other information, which may be communicated to server device 150. For example, other applications 114 may be associated with a secondary device, such as a biometric tracking device. Thus, other applications 114 may collect, capture, and/or otherwise determine user data and other information for the user, which may be used to determine interests and/or knowledge areas of the user. The user's information may correspond to locations of the user, which may further be determined using a location determination system, such as a GPS module of communication device 110 and associated systems, calendaring/scheduling information, biometrics, etc. Other applications 114 may include device interfaces and other display modules that may receive input from the user and/or output information to the user. For example, other applications 114 may contain software programs, executable by a processor, including a graphical user interface (GUI) configured to provide an interface to the user. Other applications 114 may therefore use devices of communication device 110, such as display devices, including GUIs capable of displaying information to users and other output devices, including speakers. Communication device 110 may include input devices, including touch screens. Communication device 110 may include one or more sensors or other components used to collect the current information associated with the user, such as an input device, a camera, a microphone, an accelerometer, a motion detector, an environmental sensor, and/or a biometric sensor.

Communication device 110 may further include database 116 stored on a transitory and/or non-transitory memory of communication device 110, which may store various applications and data and be utilized during execution of various modules of communication device 110. Thus, database 116 may include, for example, identifiers such as operating system registry entries, cookies associated with other applications 114, identifiers associated with hardware of communication device 110, or other appropriate identifiers, such as identifiers used for payment/user/device authentication or identification, which may be communicated as identifying communication device 110 to server device 150, historical transaction data of the user, and/or historical data associated with messages transmitted by the user including any characters, numbers, emojis, emoticons, and other inputs associated with the messages. Database 116 may include current and/or historical transaction information. Additionally, database 116 may store account information and/or account preferences for an account with server device 150. Where applicable, information used by transaction application 120 may be stored within database 116 (e.g., log-in information, payment information, preferred shopping categories etc.).

Communication device 110 includes at least one communication module 118 adapted to communicate with server device 150. In various embodiments, communication module 118 may include a DSL (e.g., Digital Subscriber Line) modem, a PSTN (Public Switched Telephone Network) modem, an Ethernet device, a broadband device, a satellite device and/or various other types of wired and/or wireless network electronic devices including microwave, radio frequency, infrared, Bluetooth, and near field electronic devices. Communication module 118 may communicate directly with nearby devices using short range communications, such as Bluetooth Low Energy, LTE Direct, WiFi, radio frequency, infrared, Bluetooth, and NFC.

Server device 150 may be implemented using any appropriate hardware and software configured for wired and/or wireless communication with communication device 110. Server device 150 may correspond to a device, server, or cloud computing architecture to conduct transactions. For example, server device 150 may provide payment to a merchant or designated recipient of the user. In certain embodiments, payment may, alternatively or additionally, be processed by a third party server or application. Server device 150 may also further be used to provide incentives for the purchase of items and/or advertisement of items to other users. Server device 150 may be managed or controlled by any suitable processing device. Although only one server device 150 is shown, a plurality of server devices may function similarly and/or be connected to process payments and/or transactions of a second party such as a payment provider (e.g., PayPal®, Venmo®, or other payment provider), merchant, recipient, and/or other party.

Server device 150 of FIG. 1 contains a transaction application 152, other applications 154, a database 156, and a communication module 158. Transaction application 152 and other applications 154 may correspond to processes, procedures, and/or applications executable by a hardware processor, for example, a software program. In other embodiments, server device 150 may include additional or different modules having specialized hardware and/or software as required.

Transaction application 152 may correspond to one or more processes to execute modules and associated specialized hardware of server device 150 to provide payment between a plurality of parties. Thus, the user of communication device 110 may be associated (e.g., own or control) a payment account associated with a payment provider and may designate one or more recipients for each individual payment transaction. Transaction application 152 may fully or partially process such payment transactions. In this regard, transaction application 152 may correspond to specialized hardware and/or software of server device 150 to provide a convenient interface to process payments between one or more accounts associated with a payment provider of server device 150.

Transaction application 152 may also provide a marketplace to sell one or more items offered by a seller (e.g., user of communication device 110) or merchant (not shown) associated with server device 150, and further provide checkout and payment processes for a transaction to purchase the items for sale from the merchant corresponding to server device 150. In this regard, transaction application 152 may correspond to specialized hardware and/or software of server device 150 to provide a convenient interface to permit a merchant offer items for sale. For example, transaction application 152 may be implemented as an application offering items for sale that may be accessed by communication device 110 to present the items for sale to the user associated with communication device 110.

In certain embodiments, transaction application 152 may correspond to a website available over the Internet and/or online content and/or database information accessible through a dedicated application. Thus, transaction application 152 may process payments designated by a user of the website, online content, or dedicated application. Additionally, other embodiments of transaction application 152 include applications that may offer items for sale as well as a payment application or an application for communication of funds between various different accounts.

Server device 150 includes other applications 154 as may be desired in particular embodiments to provide features to server device 150. For example, other applications 154 may include security applications for implementing server-side security features, programmatic client applications for interfacing with appropriate application programming interfaces (APIs) over network 150, or other types of applications. Other applications 154 may also include email, texting, voice and IM applications that allow a user to send and receive emails, calls, texts, and other notifications through network 180. In various embodiments, other applications 154 may include financial applications, such as banking, online payments, money transfer, or other applications to allow processing of transaction with the user. Other applications 154 may contain software programs, executable by a processor, including a graphical user interface (GUI) configured to provide an interface to the user.

Server device 150 may further include database 156, which may include, for example, identifiers such as operating system registry entries, cookies and/or accounts associated with transaction application 152 and/or other applications 154, historical data of accounts associated with transaction application 152 and/or other applications 154 (e.g., historical transaction data, historical message data, and/or other such historical data), identifiers associated with hardware of server device 150, or other appropriate identifiers, such as identifiers used for payment/user/device authentication or identification. Identifiers in database 156 may be used by a payment/credit provider to associate server device 150 with a particular account or group of accounts maintained by the payment/credit provider. Item, sales, and/or benefit information for items sold by the merchant associated with server device 150 may be stored to database 156. Database 156 may further include transaction information and/or results, including transaction histories.

Server device 150 includes at least one communication module 158 adapted to communicate with communication device 110. In various embodiments, communication module 158 may include a DSL (e.g., Digital Subscriber Line) modem, a PSTN (Public Switched Telephone Network) modem, an Ethernet device, a broadband device, a satellite device and/or various other types of wired and/or wireless network electronic devices including microwave, radio frequency, infrared, Bluetooth, and near field electronic devices.

Network 180 may be implemented as a single network or a combination of multiple networks. For example, in various embodiments, network 180 may include the Internet or one or more intranets, landline networks, wireless networks, and/or other appropriate types of networks. Thus, network 180 may correspond to small scale communication networks, such as a private or local area network, or a larger scale network, such as a wide area network or the Internet, accessible by the various components of system 100.

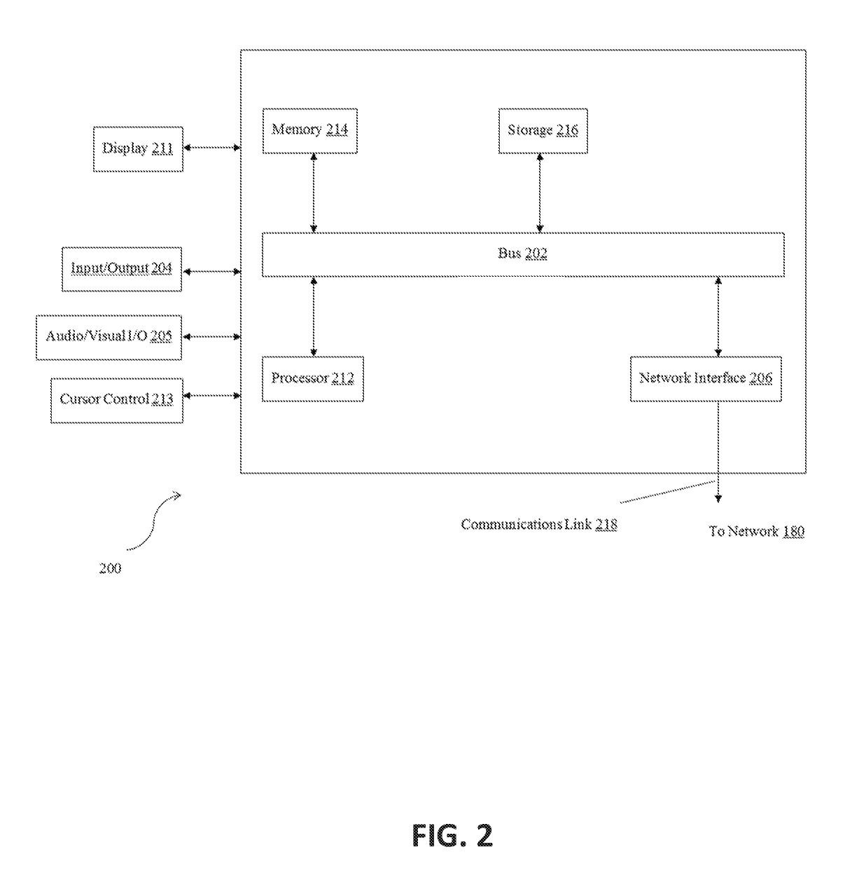

FIG. 2 is a block diagram showing an electronic device according to an embodiment of the disclosure. In various embodiments, electronic device 200 of FIG. 2 may be a smartphone, computer, tablet, personal data assistant (PDA), wearable electronic device, or other electronic device that allows a user to conduct transactions.

Electronic device 200 includes a bus 202 or other communication mechanism for communicating data, signals, and information between various components of electronic device 200. Components include an input/output (I/O) component 204 that may be used to receive inputs and/or instructions from users and provide outputs to confirm such inputs and/or instructions (e.g., through haptic feedback or noises). I/O component 204, which may be comprised of multiple devices, may also include an output component, such as a display 211, and/or a cursor control 213 (such as a keyboard, keypad, mouse, etc.). Electronic device 200 may also include an optional audio input/output component 205 to allow a user to use voice for inputting information by converting audio signals and/or output audio information to the user.

A transceiver or network interface 206 transmits and receives signals between electronic device 200 and other devices, such as another electronic device, server device, or a merchant device. One or more processors 212, which may be a micro-controller, digital signal processor (DSP), or other processing component, processes these various signals and may provide instructions for an ensuing action, such as displaying information on display 211 of electronic device 200 or transmission of the information to other devices via a communication link 218. Processor(s) 212 may also control transmission of information as well as links to other devices such as through, for example, longer ranged communications (e.g., Bluetooth® connections).

Components of electronic device 200 may also include a system memory component 214 (e.g., RAM) and/or a static storage component 216 (e.g., ROM). Electronic device 200 performs specific operations by processor(s) 212 and other components by executing one or more sequences of instructions contained in system memory component 214 and/or a static storage component 216. Logic may be encoded in a computer readable medium, which may refer to any medium that participates in providing instructions to processor(s) 212 for execution. Such a medium may take many forms, including but not limited to, non-volatile media, volatile media, and transmission media. In one embodiment, the logic is encoded in non-transitory computer readable medium.

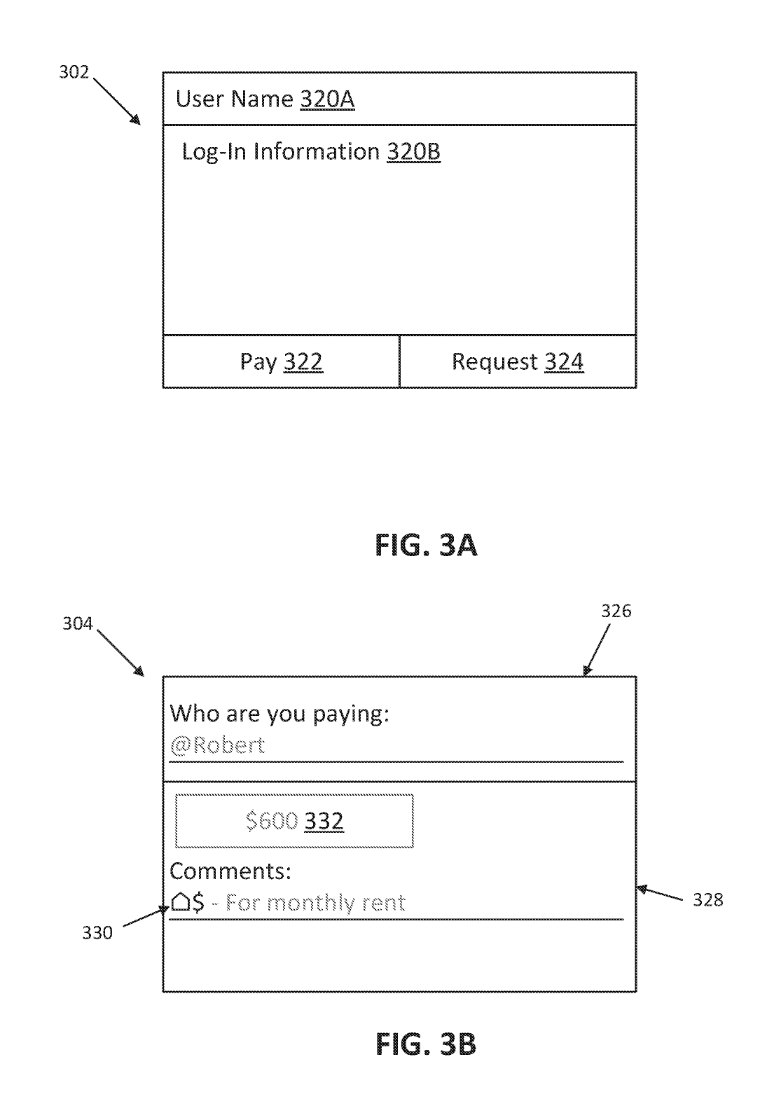

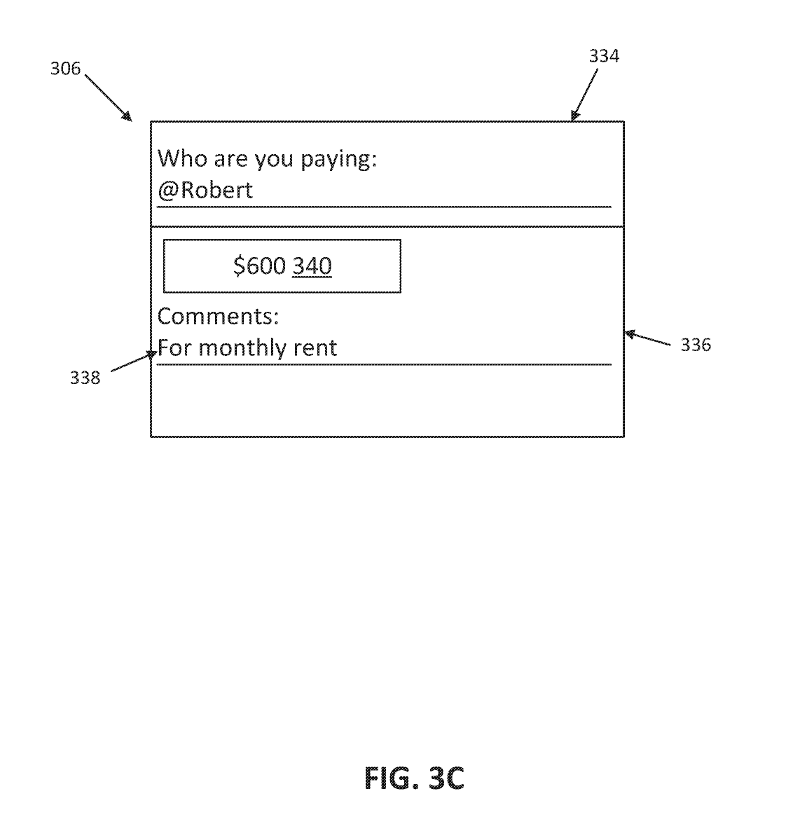

FIGS. 3A-C are views of an example graphical user interface (GUI) showing a transaction using predictive contextual messages according to an embodiment of the disclosure. FIG. 3A illustrates a view 302. View 302 may be an initial screen shown on a display of an electronic device used by a user when the user wishes to conduct a transaction.

In view 302, a user of a transaction account (e.g., an account for providing payment to one or more other users) may not yet have logged in. Thus, view 302 allows a user to input his or her user name 320A (which may be the user's actual name, an ID, an e-mail address, a log-in name, a temporary ID, and/or other such name that identifies the user) and log-in information 320B. Log-in information 320B may include a password, asking the user to biometrically authenticate through one or more components of the electronic device (e.g., via a fingerprint sensor), requesting the user to answer one or more personal questions, and/or other authentication and log-in techniques.

Additionally, the user may be presented with transaction options such as payment selection 322 and request selection 324. If the user selects payment selection 322, the user may instruct the payment provider to pay one or more other parties from one or more accounts of the user. If the user selects request selection 324, the user may request funds from one or more other parties. Payment selection 322 and request selection 324 may be presented to the user before, during, or after the user has logged in and authenticated himself or herself with the payment provider services. The techniques described herein may be used when the user selects payment selection 322 (to pay another party), request selection 324 (to request payment from another party), and/or with other types of transactions (e.g., when purchasing or providing an item or service for sale and/or when sending a message to other users). Additionally, FIGS. 3A-C are illustrative and certain embodiments of the techniques described herein may include fewer or additional views or steps.

After the user has logged in, been authenticated, and selected a transaction type, the technique may proceed to view 304 as shown in FIG. 3B. View 304 may be a screen where a user can provide details of a transaction. As shown in FIG. 3B, view 304 may include a secondary party input section 326, a comment section 328, and a transaction amount section 332.

Secondary party input section 326 may allow for a user to select a secondary party (e.g., other party) to conduct the transaction with. For example, as shown in FIG. 3B, secondary party input section 326 may allow for a user to select a recipient. Transaction amount section 332 may allow for a user to select a transaction amount or, in other embodiments, a transaction item or service.

However, as shown in FIG. 3B, the user may not be required to fill out secondary party input section 326 and transaction amount section 332. Instead, the user may provide one or more comments to comment section 328. Comment section 328 may allow for a user to input one or more comments (e.g., comments describing the transaction). In certain embodiments, instead of filling out secondary party input section 326 and transaction amount section 332, the user may provide one or more comments and, in response, secondary party input section 326 and transaction amount section 332 may be auto-filled. Accordingly, when a user inputs one or more comments to comment section 328, the electronic device of the user and/or a server device may provide such predictions as auto-fill suggestions for secondary party input section 326 and/or transaction amount section 332.

Such predictions may be based on, for example, previous transactions of the user (e.g., if the comments for the current transaction matches comments for a previous transaction, details of the previous transaction may be suggested), a time period of the payment (e.g., the time of the month, week, or day may be detected and transactions or recurring transactions, such as monthly rent or a recurring Tuesday night dinner bill, may be suggested if there is a time period match), a location of the user (e.g., if the user is detected to be located at a restaurant, recipients and/or amounts for previous transactions that split a check at the restaurant or provided for payment of a bill of the restaurant may be suggested), whether electronic devices of contacts of the user is detected within the vicinity of the user (e.g., if one or more social media contacts of the user is detected to be within 20 feet of the user, such social media contacts may be suggested as the secondary input), and/or other data that may allow for more accurate predictions of the recipient, amount of payment, and/or other details of the transaction. As more data is input by the user or determined by the system, more accurate auto-filling may be possible. For example, if the user identifies a recipient, based on past transactions between the user and the particular recipient, the system may identify closer matches and provide more accurate or complete auto-fill data. Thus, as the user inputs data to a message, auto fill data may change based on the additional user-supplied data, including emojis, emoticons, and other image-based data.

Comment section 328 may be configured to receive comments. Such comments may include emojis and/or emoticons. In certain embodiments, emojis and/or emoticons received may be converted into standard text. As such, emojis and/or emoticons may correspond to and be converted into one or more letters, numbers, words, phrases, sentences, and/or paragraphs. For example, the emoji “ [symbol] ” may be converted into “house.”

In certain embodiments, the comments, including any emojis and/or emoticons may be associated with historical transactions. Thus, when the user inputs “ [symbol] ” into the comment section, one or more processors of the electronic device and/or the server device may search within one or more memories storing historical transactions to find any historical transactions with “ [symbol] ” in the comments. This may be specific to the user, or if the user does not have any or has a low amount of transactions with that emoji, historical transactions of other users may be used. Searches may also be conducted to identify historical transactions for anything associated with a home or house, such as monthly rental payments, mortgage payments, utility payments, internet or entertainment (e.g., Netflix®) payments, or other such payments. A match score for such historical transactions may then be determined and the historical transaction or transactions that has or have the highest match score(s) may be suggested.

The user may input additional characters such as emojis and/or emoticons within comment section 328. Such additional emojis and/or emoticons may allow for a more accurate match. Thus, while a user entering only “ [symbol] ” may cause the system (e.g., the electronic device, the server device, and/or any other devices associated with the transaction) to identify historical transactions for anything associated with a home or house, if the user enters “ [symbol] ¥” the system may identify transactions associated with a home or house located in Japan. Thus, the system may determine that the user has a rental payment for an apartment in Tokyo and may suggest details of such a rental payment to the user (e.g., the landlord may be the payment recipient and the amount may be a historical amount of rent that the user pays per month). The user may then accept or reject the suggestion. Other embodiments may allow for any number of characters, symbols, emojis, and/or emoticons (e.g., may allow for three, four, or five or more characters, symbols, emojis, and/or emoticons when determining an associated transaction).

Such suggestions may be provided within view 304. For example, as shown in FIG. 3B, after the user has entered comment 300 that includes the emojis “ [symbol] $” in comment section 328, the system may determine that the closest match to such emojis is a monthly rent payment. Thus, the system may provide details for a historical monthly payment as a suggestion. In FIG. 3B, such a suggestion may include Robert as the payment recipient in secondary party input section 326, $600 as the payment amount in transaction amount section 332, and the comment “For monthly rent” in comment section 328. The suggestions may be in a different font, text color, or may include other characteristics (e.g., in parenthesis) that identify the suggestions until they are accepted.

In certain embodiments, a plurality of suggestions (e.g., two suggestions, three suggestions, or four or more suggestions) may be provided and the user many select or revise one or more of the suggestions or reject all suggestions. The plurality of suggestions may be the suggestions that are determined by the system to provide a best match to the comments or data provided by the user. If the user selects one of the plurality of suggestions, the match score associating the selected detail with the comment may be increased and/or the match score associating the comments with the not selected or revised detail may be decreased. Thus, if the user consistently accepts a certain recipient, transaction, and/or suggested comments when using a certain emoji combination, such an emoji combination may have a high match score with the recipient, transaction, and/or suggested comments. For systems that are normally configured to suggest a plurality of historical transaction in response to a comment, such a high match score may instead result in the system suggesting only details of that one historical transaction (e.g., if the system assigns match scores on a scale of 1 to 100 and such a historical transaction has a match score of 100 and/or has a match score above 80 and is also twice that of the next highest match score, only that one historical transaction may be suggested).

Additionally or alternatively, additional factors other than the comments and/or historical transaction data may be used to determine suggestions. Such factors may include, for example, previous transactions of the user, a time period of the payment, a location of the user, whether electronic devices of contacts of the user is detected within the vicinity of the user, a social network of the user, an electronic calendar of the user, and/or other data that may allow for more accurate predictions of the recipient, amount of payment, and/or other details of the transaction. As an example, the system may use a social network of the user to determine a list of possible recipients from the user's social network friends. The system may then determine if any of the user's friends have recently checked into the same place that the user checked into. The system may also determine if the check-ins are around the same time as the user. If so, the system may suggest the friend as a recipient as well as a typical, historical, or other amount as the transaction amount (e.g., if the location is a movie theater, the movie ticket price may be suggested). In certain such embodiments, the additional factors may be used if comments provided do not return a match or return only low match scores with any historical transaction data, if there is no historical transaction data at all, or may be used along with the comments.

After the system has suggested details of the historical transaction to the user, the user may accept the suggested historical transaction. Thus, as shown in FIG. 3C, view 306 shows that the user has accepted the suggestion of FIG. 3B. Accordingly, an input section 334 lists the recipient as Robert, a transaction amount section 340 lists the amount as $600, and a comment section 336 includes the comment “For monthly rent.” All such suggestions have been accepted and so, while in FIG. 3B, such suggestions were in a different font or text color, in FIG. 3C, the font or text color has been changed to show that the suggestion has been accepted. Note that while embodiments described herein are focused on payment-related messages or transactions, any type of electronic transaction or message may be used with the auto-fill ideas, such as a request for a meeting, an announcement or greeting, an update, or sharing specific content.

The user may accept the suggestion, for example, by selecting an “Accept” button, pressing space, tab, or another key, not inputting anything for a time period (e.g., 3 seconds), not deleting the suggestion with a time period, or through another indication that the user accepts the suggestion. Once the user has accepted the suggestion, the sections may be populated, but the user may also modify some of the sections (e.g., the amount in the transaction amount section 340 may be modified).

In various embodiments, the user may instead reject the suggestion, for example, by selecting a “Reject” button, pressing a deletion key, activating another key, continuing to input comments different from that suggested, deleting the suggestions, or indicating through another action that the user rejected the suggestion. Feedback may then be provided to the system that allows for updates to the match score between the message and the suggestion. In certain embodiments, such feedback may result in the match score being increased for just a portion of the suggestion (e.g., if the user confirms the recipient, the match score for the recipient may be increased) while the match score for another portion of the suggestion may be decreased (e.g., if the user then modifies the transaction amount, the match score for that specific transaction amount may be decreased). Other embodiments may allow for match scores for suggestions or a portion thereof to stay the same.

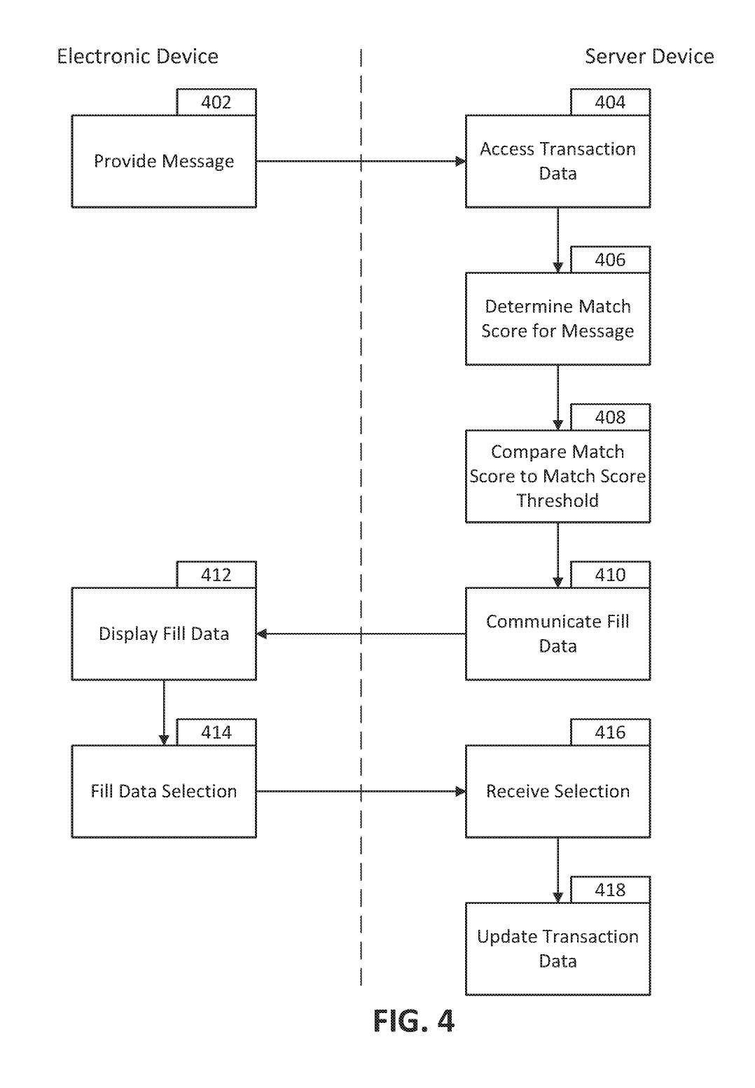

FIG. 4 is a flowchart showing an example of a transaction utilizing predictive contextual messages according to an embodiment of the disclosure. FIG. 4 describes a transaction technique where portions of the technique are performed between an electronic device of a user and a server device. FIG. 4 describes an example technique performed by sending data associated with a user's input to the server device. The server device then determines one or more suggestions for the user.

In block 402, the user may load a transaction window and provide a message (e.g., a comment as shown in FIGS. 3A-C). The message may be inputted into a comment section of the transaction window or any other desired input field. The message may then be sent to the server device. The message may include one or more emojis and/or emoticons. Additionally or alternatively, in certain embodiments, additional data, such as the location of the user, may be transmitted to the server device without any input needed by the user.

After the server device receives the message and any other data associated with the message, the message may, in certain embodiments, be converted to text and/or another form of data that allows for the server device to calculate a match score for one or more historical transactions conducted by the user. The server device may then access the historical transaction data in block 404 and a match score for one or more of the historical transactions may be determined in regards to the message in block 406. The match score may be determined through any of the techniques described herein. In certain embodiments, the match score may be a numerical score, such as on a scale of 1 to 10 or 1 to 100. Other embodiments of the match score may simply categorize the match between the comment and the transaction into one of a plurality of categories (e.g., low, medium, or high).

In block 408, the match score may be compared to a match score threshold. In embodiments where the match score is a numerical score, the threshold may be a numerical threshold. Transactions with a match score higher than the threshold may be provided as a suggestion while transactions lower than the threshold may not be provided as a suggestion. If no transaction is higher than the threshold, the server device may transmit data requesting that the user manually enter transaction details or use historical transaction data from other users. Manually entered details may also be communicated to the server device and scored for future use. In certain examples, such manually entered details may be associated with the message or other details and thus, a match score may be assigned.

Initially, for a given historical transaction and message, the match score may be lower, but as the amount of times the user selects or enters transaction details that match the message or other details increase, the match score may accordingly be increased. Thus, match scores for various transactions may be developed over a period of time. In certain other embodiments, if no transaction has a match score higher than a lowest threshold, server device may determine that the transaction is possibly fraudulent. A fraud alert may then be issued to the user to determine if the transaction is indeed fraudulent.

Additionally, multiple thresholds may be provided. Such thresholds may be tiered thresholds. If the transaction and the message have a match score that is higher than only a first threshold, the server device may communicate certain transactions details to the electronic device (e.g., just the recipient), while, if the match score is higher than a second threshold that is higher than the first threshold, additional details may be communicated (e.g., both the recipient and the amount may be communicated). As the match score increases and becomes higher than all thresholds, full details of the transaction may be communicated.

The transactions with the highest match scores (e.g., the three highest match scores) that are higher than the threshold may be communicated to the electronic device in block 410. Such historical transactions may be communicated as fill data to auto-fill one or more transaction categories. Such fill data may include the recipient, the transaction amount, the purpose of the transaction, comments for the transaction, the time to conduct the transaction (e.g., the system may determine that rental payment may be provided on the first of the month even though the user may be entering details of the rental payment on another day), and/or other such information.

The electronic device may receive the fill data and display the fill data through auto-fill suggestions in block 412. If multiple sets of fill data (e.g., fill data for multiple transactions) are provided, the multiple sets may be displayed to the user at the same time (e.g., the user may select from a list of auto-fill options), may be displayed to the user one at a time (e.g., the highest match score fill may be displayed and if the user rejects the auto-fill, the next highest match score fill may be displayed), or may only be displayed if the user provides an indication that he or she wishes to be provided with auto-fill options (e.g., through pressing of a designated auto-fill button or key).

In block 414, the user may select one of the auto-fill options (to approve or revise) or may reject all of the provided options. After the user has made his or her selection, data associated with whether the user has accepted or revised any of the auto-fill selections or rejected all selections may be communicated to the server device in block 416. The user's selection, revision, or rejection may then be used to update the transaction data in block 418. Thus, for example, the match score of the transaction to the message and/or additional data input by the user may be updated. Accordingly, if the user confirms a selection, the match score for the selection may be increased while, if the user rejects a selection, the match score for the selection may be decreased. In certain embodiments, the match score for certain selections may be unchanged (e.g., if the user does not affirmatively reject the selection). Such updated match scores may then be used to provide auto-fill selections for future messages and/or transactions.

As a result, a user composing an electronic message through a user device, such as a smart phone, may not need to compose or enter the complete message, as the system may predict what the user is intending to send, such as based on entered emojis, emoticons, or other message data, and auto-filling additional or remaining content of the message for the user based on historical transactions conducted by or messages sent by the user that share message data input by the user or obtained by the system.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The various features and steps described herein may be implemented as systems comprising one or more memories storing various information described herein and one or more processors coupled to the one or more memories and a network, wherein the one or more processors are operable to perform steps as described herein, as non-transitory machine-readable medium comprising a plurality of machine-readable instructions which, when executed by one or more processors, are adapted to cause the one or more processors to perform a method comprising steps described herein, and methods performed by one or more devices, such as a hardware processor, user device, server, and other devices described herein.

What is claimed is:

1. A system comprising:
a non-transitory memory; and
one or more hardware processors coupled to the non-transitory memory and configured to read instructions from the non-transitory memory to cause the system to perform operations comprising:
receiving a message comprising a symbol from an electronic device;
accessing transaction data associated with a transaction;
determining a match score based on an association of the transaction data with the symbol;
determining that the match score is higher than a first threshold;
determining fill data based on the transaction data in response to determining that the match score is higher than the first threshold; and
communicating the fill data to the electronic device for display on a graphical user interface (GUI) of the electronic device.

2. The system of claim 1, wherein the transaction comprises a historical transaction associated with a comment that includes the symbol, and wherein the fill data comprises data matching a detail of the transaction.

3. The system of claim 1, wherein the operations further comprise:
receiving a user selection of the fill data; and
updating the transaction data associated with the transaction in response to the user selection of the fill data.

4. The system of claim 1, wherein the transaction data comprises a plurality of transactions and wherein the operations further comprise:
determining match scores based on associations with the symbol for each of the plurality of transactions;
determining that two or more match scores of the plurality of transactions are higher than the first threshold;
determining fill data associated with the two or more transactions; and
communicating the fill data associated with the two or more transactions to the electronic device for display on the GUI.

5. The system of claim 1, wherein the operations further comprise:
receiving location information from the electronic device, wherein the match score is further determined based on an association of the transaction data with the location information.

6. The system of claim 1, wherein the fill data comprises a payment amount or a recipient.

7. The system of claim 1, wherein the symbol comprises an emoji and wherein determining the match score comprises converting the symbol to text.

8. A method comprising:
receiving a message comprising a symbol from an electronic device associated with a user;
accessing message data associated with a past message sent by the user;
determining a match score based on an association of the message data with the symbol;
determining that the match score is higher than a first threshold;
determining fill data based on the message data in response to determining that the match score is higher than the first threshold; and
communicating the fill data to the electronic device for display on a graphical user interface (GUI) of the electronic device.

9. The method of claim 8, wherein the past message comprises a historical message associated with a comment that includes the symbol, and wherein the fill data comprises data matching a detail of the past message.

10. The method of claim 8, further comprising:
receiving a user selection of the fill data; and
updating the message data associated with the message and/or the past message in response to the user selection of the fill data.

11. The method of claim 8, wherein the message data comprises a plurality of messages and wherein the method further comprises:
determining match scores based on associations with the symbol for each of the plurality of messages;
determining that two or more match scores of the plurality of messages are higher than the first threshold;
determining fill data associated with the two or more messages; and
communicating the fill data associated with the two or more messages to the electronic device for display on the GUI.

12. The method of claim 8, further comprising:
receiving location information from the electronic device, wherein the match score is further determined based on an association of the message data with the location information.

13. The method of claim 8, wherein the fill data comprises a payment amount or a recipient.

14. The method of claim 8, wherein the symbol comprises an emoji and wherein determining the match score comprises converting the symbol to text.

15. A non-transitory machine-readable medium having stored thereon machine-readable instructions executable to cause a machine to perform operations comprising:
receiving a message comprising a symbol from an electronic device;
accessing transaction data corresponding to a transaction associated with the symbol;
determining a match score based on an association of the transaction data with the message;
determining that the match score is higher than a first threshold;
determining fill data based on the transaction data in response to determining that the match score is higher than the first threshold; and
communicating the fill data to the electronic device for display on a graphical user interface (GUI) of the electronic device.

16. The non-transitory machine-readable medium of claim 15, wherein the transaction comprises a historical transaction associated with a comment that includes the symbol, and wherein the fill data comprises data matching a detail of the transaction.

17. The non-transitory machine-readable medium of claim 15, wherein the operations further comprise:
receiving a user selection of the fill data; and
updating the transaction data associated with the transaction in response to the user selection of the fill data.

18. The non-transitory machine-readable medium of claim 15, wherein the transaction data comprises a plurality of transactions and wherein the operations further comprise:
determining match scores based on associations with the symbol for each of the plurality of transactions;
determining that two or more match scores of the plurality of transactions are higher than the first threshold;
determining fill data associated with the two or more transactions; and
communicating the fill data associated with the two or more transactions to the electronic device for display on the GUI.

19. The non-transitory machine-readable medium of claim 15, wherein the operations further comprise:
receiving location information from the electronic device, wherein the match score is further determined based on an association of the transaction data with the location information.

20. The non-transitory machine-readable medium of claim 15, wherein the message further comprises a recipient identifier and wherein the transaction is further associated with the recipient identifier.
